(19) United States
(12) Patent Application Publication
(10) Pub. No.: US 2026/0336946 A1
(43) Pub. Date: Oct. 29, 2026

(54) APPARATUS AND METHOD FOR SORTING RANDOMLY FED CLOSING ELEMENTS OF DIFFERENT TYPES OR FORMATS

(71) Applicant: RONCHI MARIO S.P.A., GESSATE (IT)

(72) Inventor: CESARE RONCHI, GESSATE (IT)

(21) Appl. No.: 19/147,031

(22) PCT Filed: Feb. 6, 2024
(86) PCT No.: PCT/IB2024/051072

§ 371 Date: Jul. 10, 2025

(30) Foreign Application Priority Data
Feb. 7, 2023 (IT) 102023000002034
Feb. 7, 2023 (IT) 102023000002049
Feb. 7, 2023 (IT) 102023000002055

(51) Int. Cl. B65G 47/24; B65G 43/08; B65G 47/90

(52) U.S. Cl. CPC B65G 47/24; B65G 43/08; B65G 47/90; B65G 2201/0235; B65G 2203/0225; B65G 2203/041

(57) ABSTRACT

Amendments to the abstract were made herewith to correct minor informalities with the parent application. A clean copy of the abstract is included herewith on a clean sheet. Even in light of the amendments no new matter is being added and all amendments are fully supported by the specification as filed.

The present invention relates to a sorting apparatus for sorting randomly fed closing elements and a method for sorting randomly fed closing elements.

It is known in the technical sector relating to the packaging of products, for example in liquid, fluid or powder form, that there exists the need to fill, with the desired product, containers which have different capacities and shapes and then close the filled container with a respective closing element.

For this purpose, automatic filling and capping machines are known, these being designed to fill, close and then forward the filled containers for packaging.

It is also known that these automatic machines must generally be supplied continuously, at a regular pitch and/or at a constant speed, these parameters being determined by the requirements of the said machines.

For this purpose, feeding apparatus—conventionally called “sorting machines”—have been developed, these apparatus being able to feed containers, which are initially arranged randomly inside special hoppers, in an orderly sequence to said downstream operating machines.

In the technical sector of filling/capping machines with a high production speed, which are generally of the rotating type, there exists the further problem of feeding the closing elements for capping the containers to the input of the filling/capping machine, which generally requires an orderly flow of closing elements arranged with a predefined orientation and/or position (e.g. upright position).

The sorting of closing elements designed to close the containers poses more complex problems than the sorting of the containers, since the closing elements, differently from other articles such as bottles, may have geometric forms such that many different positions and arrangements (orientations) are possible when the closing elements are randomly fed on a transport system such as a conveyor belt. In addition, some closing elements are unable to remain self-supporting in a predefined stable position, in particular in an upright position.

In this context it is also known that different types and formats of closing elements exist. For the purposes of the description of the present invention, for the sake of simplicity, three main types of closing element are identified, i.e. caps, sprayers (or dispensers) and triggers.

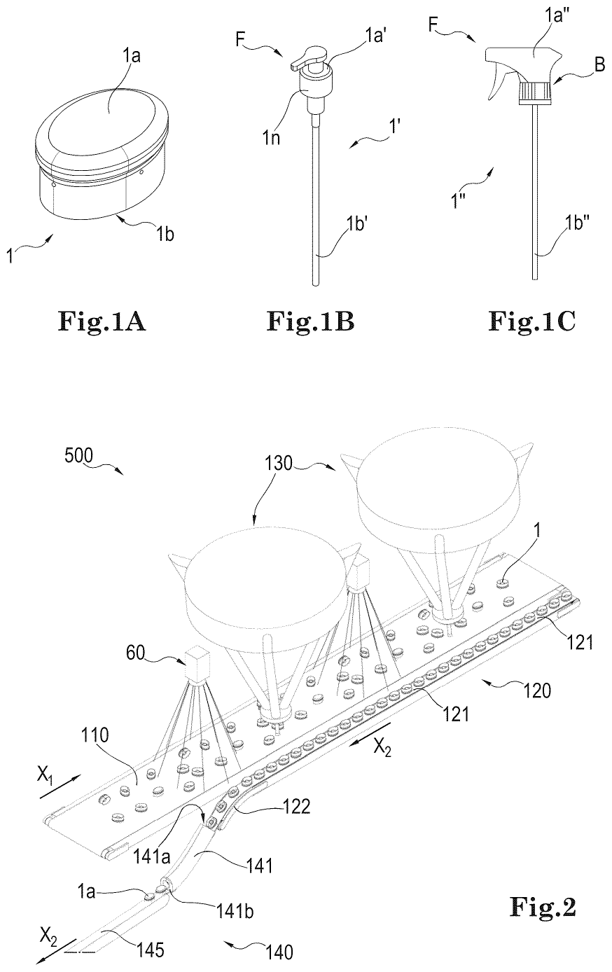

FIG. 1a shows an example of a closing element in the form of a cap 1, with a top head 1a and a bottom cavity 1b arranged opposite each other along a main vertical axis and connected by a side surface with a substantially elliptical cross-section.

FIG. 1b shows an example of a closing element of the sprayer 1′ or dispenser type, which has a top head 1a′, a neck In situated underneath the head 1a′ and a bottom stem 1b′ with a vertical axis.

FIG. 1c shows an example of a closing element of the trigger type 1″ which has a top head 1a″ and a bottom stem 1b′ with a vertical axis.

In the case of the sprayer 1′ and the trigger 1″, a front side F—conventionally assumed as being that with the dispensing mouth—and an opposite rear side B are also identified.

In the context of the present invention, reference will be generally made to the position of the closing element when referring the orientation of its main (vertical) axis, understood as corresponding to the axis of insertion onto the mouth of the container onto which it must be fitted. The position may in particular be vertically upright, laid flat on a plane perpendicular to the vertical direction, or inclined at an angle with respect to these two positions. Reference will instead be generally made to an orientation of the closing element in order to refer to a specific orientation of its elements (head, bottom) and/or its surfaces (conventionally identified as front, side, rear in relation to the main vertical axis).

These definitions are however proposed here only for the sake of easier description and do not have a limiting meaning.

In most of the applications, in order to allow correct application of the closing element onto the associated container, the closing elements must be fed to the downstream filling/capping machines always in a certain position, generally vertical upright position, and/or with a specific orientation of its elements (head, bottom) and/or its surfaces, in relation to a vertical axis, to the position of the head and/or to the direction of feeding through the machine.

Examples of the prior art solutions according to the preamble of claim 1 are disclosed into US 2022/306400 MARTI SALA.

According to particular aspects of the present invention, for the types of closing elements shown in FIGS. 1a-1c, the following predefined position/orientation is preferred:
a. Caps: upright position with head (continuous upper surface) directed upwards;
b. Sprayers: vertical upright position with head directed upwards. The front side F with dispenser may be oriented in any direction, preferably the rear side B is directed towards the extraction direction;
c. Triggers: vertical upright position with head directed downwards and rear side B directed towards the extraction direction.

The technical problem which is posed, therefore, is that of providing an apparatus for sorting closing elements, such as caps, triggers or sprayers for closing containers, which is able to sort the randomly fed closing elements so that they are fed to input devices of downstream operating machines, such as filling, capping or labelling machines, providing a solution to or at least partially overcoming one or more of the aforementioned problems of the prior art.

A particular object of the present invention is that the apparatus should be able to sort randomly fed closing elements (caps, sprayers, triggers), which must be fed to the downstream operating machines with a certain predefined position and/or orientation.

Another particular object of the present invention is that the apparatus should be able to sort closing elements of a different type or format.

A further desirable aspect is that the apparatus should be able to sort asymmetrical closing elements.

A further desirable aspect is that the apparatus should be able to allow rapid modification of the format or type of closing elements to be applied, limiting to a minimum the format-changing operations and machine downtime of the apparatus.

Within the context of this problem, it is also desirable that the apparatus should have small dimensions, be easy and inexpensive to produce and assemble and be able to be easily installed at any user location; in particular it is preferable that the apparatus should allow the use of simple and fast devices, without negatively affecting the sorting efficiency.

These results are obtained according to the present invention by a method for sorting closing elements with the features of the attached claims.

The invention therefore relates to a sorting method for sorting randomly fed closing elements, comprising:
transporting a plurality of closing elements for closing containers, arranged randomly on an input conveyor plane;
detecting the position and the arrangement of the closing elements in transit on the input conveyor surface, by means of a detection system and making the information available to a control unit for controlling one or more pick and place devices;
picking up one or more of the closing elements randomly arranged on the input conveyor plane and positioning them in an intermediate transport system with a predefined intermediate position and orientation, by means of said one or more pick and place devices which perform movements for orientation and positioning of the picked-up closing elements, controlled by the control unit based on the position and arrangement information detected;
transporting the one or more closing elements positioned in the intermediate transport system to the input of an extraction system, with feeding of the closing elements into the extraction system;
outputting from the extraction system an orderly flow of closing elements which advance with a predefined extraction position and orientation;
   wherein the extraction system comprises: a transition assembly, which includes the input of the extraction system which receives the plurality of closing elements and feeds to an output of the transition assembly the closing elements received at the input and arranged with the predefined extraction position and orientation; and an extraction conveyor, which receives at its input the closing elements output from the transition assembly and transports to its output the orderly flow of closing elements which advance in an extraction direction with the predefined extraction position and orientation.

The input plane, the intermediate transport system, the pick and place devices and the extraction system form in this way a line for sorting closing elements, wherein the method for sorting the randomly arranged elements in order to obtain the sorted flow with the predefined extraction position and orientation is adjusted by the combination of the orientation and positioning settings of the pick and place devices for the intermediate position and orientation positioning and by the configuration of the transition assembly.

With the method it is therefore possible to sort easily randomly arranged closing elements, resulting in an orderly flow which is correctly positioned and oriented for feeding to the following downstream apparatus. The sorting line is able to manage many different arrangements of the closing elements on the input plane and may be adjusted in order to manage different closing element formats.

Preferably, the one or more pick and place devices perform orientation and positioning movements which require a number of axes of rotation and/or degrees of freedom less than or equal to five.

In preferred embodiments, the transition assembly receives at its input the closing elements in a first position and/or orientation and transports them, varying the position and/or orientation thereof, so as to feed them to the input of the extraction conveyor with the predefined extraction position and/or orientation. In particular, the transition assembly may vary the position of the closing elements by means of a rotation about a longitudinal axis, perpendicular to a main vertical axis of the closing element, or vary the orientation of the closing elements by means of a rotation about a main vertical axis of the closing element.

The method is particularly suitable for sorting closing elements of the cap, sprayer or trigger type described above.

In preferred embodiments, at least one of the predefined intermediate position and orientation and the predefined extraction position and orientation is a vertical upright position with the head directed upwards.

In further embodiments, preferred for the transport of closing elements with trigger heads, the predefined intermediate position and orientation may be a position laid flat on a side surface thereof, and the extraction position and orientation may be a vertical upright position, with the head directed downwards.

The extraction conveyor defines preferably a longitudinal/transverse plane on which the closing elements advance arranged with said predefined extraction position and orientation.

The intermediate transport system may comprise: a transport plane, or a plurality of holding elements designed to hold a closing element and movable between a positioning zone, in which they receive a closing element positioned by one of the pick and place devices, and an exit part for output towards the input of the extraction system. The holding elements move in particular along an oval circuit between the positioning zone and an exit part for output towards the input of the extraction system.

In some embodiments, the intermediate transport system rotates the closing elements through 180 degrees about a vertical axis between the positioning zone for input into the intermediate system and the input into the extraction system.

More generally, the closing elements are preferably fed to the input of the extraction system with a predefined position and/or orientation different from the intermediate position and/or orientation with which they are positioned in the intermediate transport system and/or different from the predefined extraction position and/or orientation. In particular, said predefined position and orientation for input into the extraction system may be a position and orientation rotated through 180 degrees about a main vertical axis of the closing elements, with respect to the intermediate position and orientation and/or a position and orientation of each closing element rotated about a longitudinal axis with respect to the intermediate position and orientation and/or the extraction position and orientation, in particular with an angle of rotation of between 90 and 180 degrees.

Advantageously, the method is able to manage in a versatile manner different positions, arrangement, types and formats of the closing elements, by varying the sorting line configurations. For example it is possible: to vary by means of the control unit a control setting of the pick and place devices for positioning the closing elements in the intermediate transport system; and/or to use a different intermediate system and a different extraction system, for sorting of the closing elements of a different type and/or format; and/or to replace the transition assembly of the extraction assembly with a different transition assembly for sorting closing elements of a different type and/or format; and/or to use at least two different series of holding elements in the intermediate transport system in order to vary the input interval between the closing elements in the extraction system and/or to hold closing elements of a different type and/or format.

Further details and technical advantages of the invention may be obtained from the following description of non-limiting examples of embodiment of the subject of the present invention, provided with reference to the attached drawings, in which:

FIG. 1a shows an example of a closing element in the form of a cap;

FIG. 1b shows an example of a closing element of the sprayer or dispenser type;

FIG. 1c shows an example of a closing element of the trigger type;

FIG. 2 shows an elevated perspective view of a first embodiment of a sorting apparatus 100 for sorting closing elements in the form of caps;

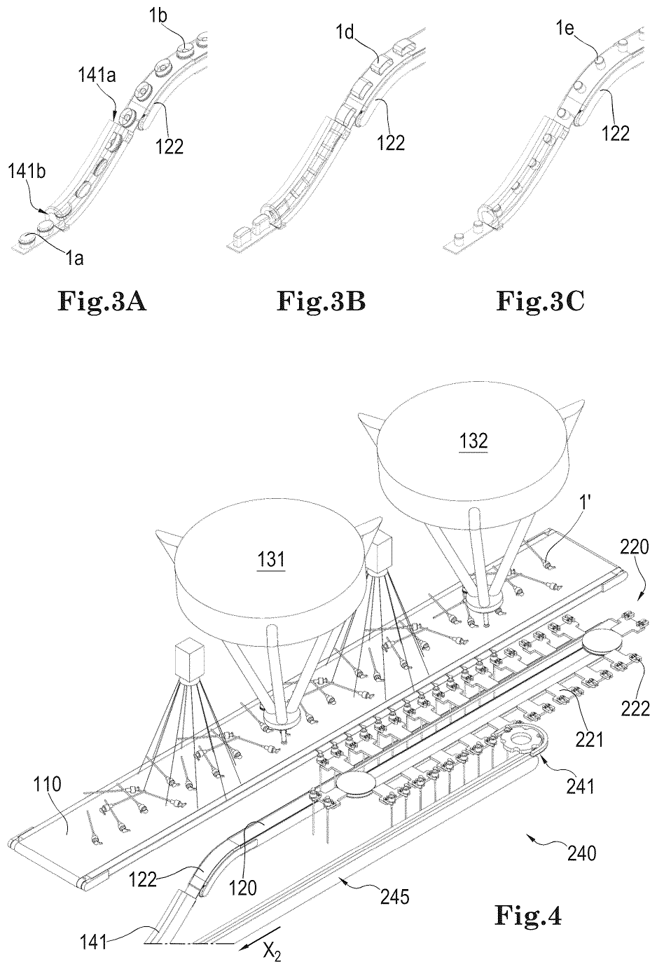

FIGS. 3A-3C show detailed views of different variants of a transition assembly of the extraction system of the apparatus according to FIG. 2;

FIG. 4 shows an elevated perspective view of a second embodiment of a sorting apparatus for sorting closing elements in the form of caps or sprayers;

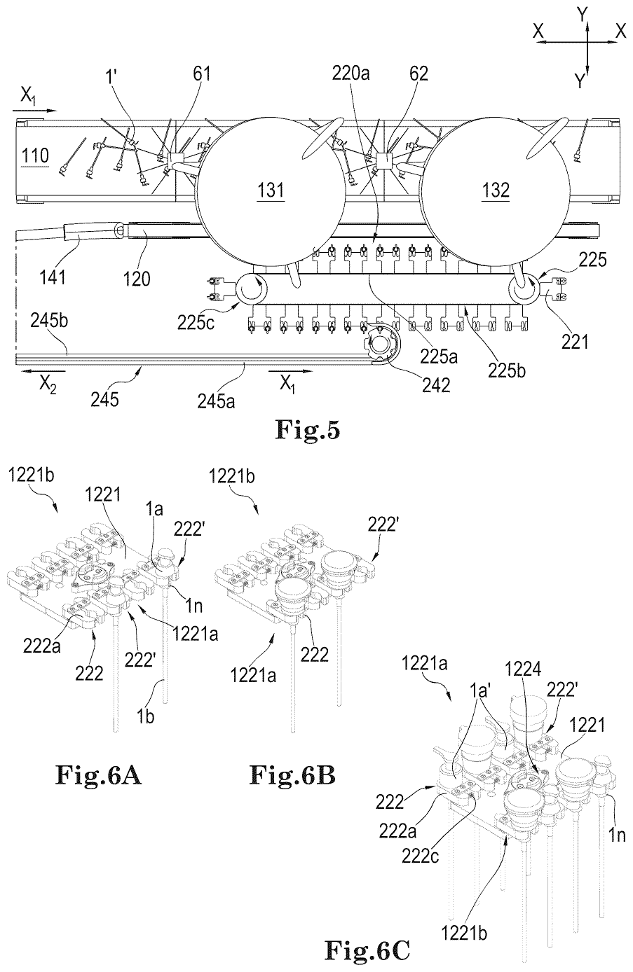

FIG. 5 shows a top plan view of the sorting apparatus according to FIG. 4;

FIG. 6A shows a perspective view of a preferred embodiment of a support plate, which carries a plurality of holding elements, with a series of holding elements gripping a respective closing element;

FIG. 6B shows the support plate according to FIG. 6A with a different series of holding elements gripping a respective closing element with a different format;

FIG. 6C shows the support plate according to FIG. 6A which carries a plurality of holding elements gripping closing elements of a different type and/or format;

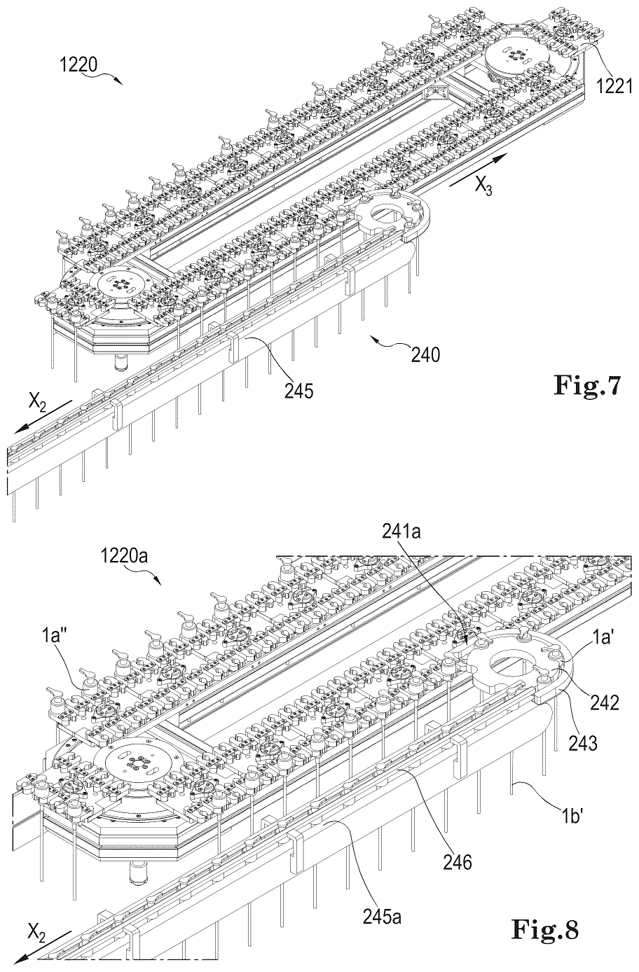

FIG. 7 shows a perspective view of a preferred variation of embodiment of the intermediate transport and extraction systems of the sorting apparatus according to FIG. 4;

FIG. 8 shows a partial enlarged view of the intermediate transport and extraction systems according to FIG. 7;

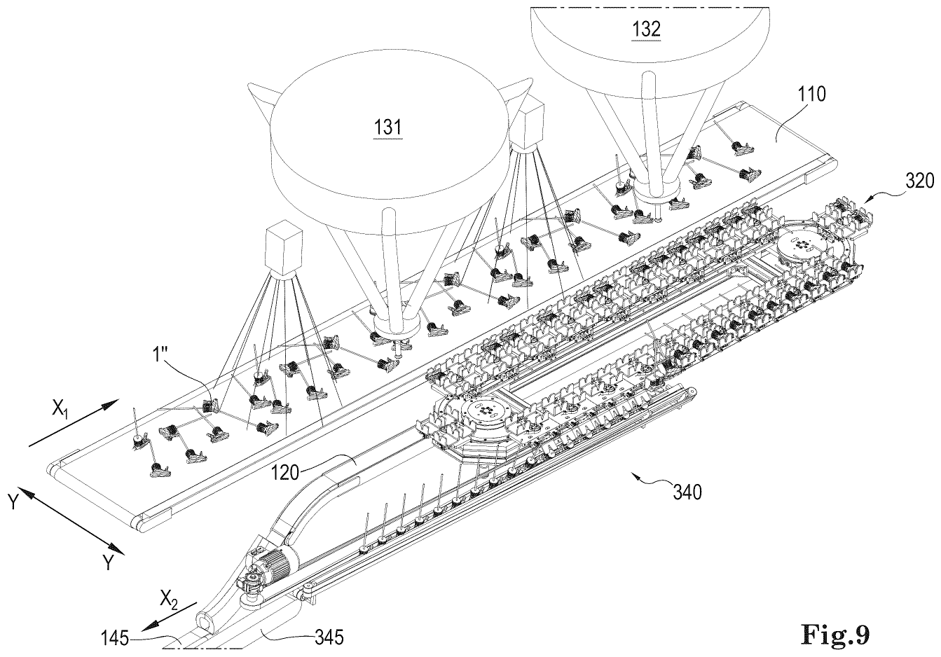

FIG. 9 shows a perspective view of a third embodiment of a sorting apparatus for sorting closing elements in the form of caps or triggers;

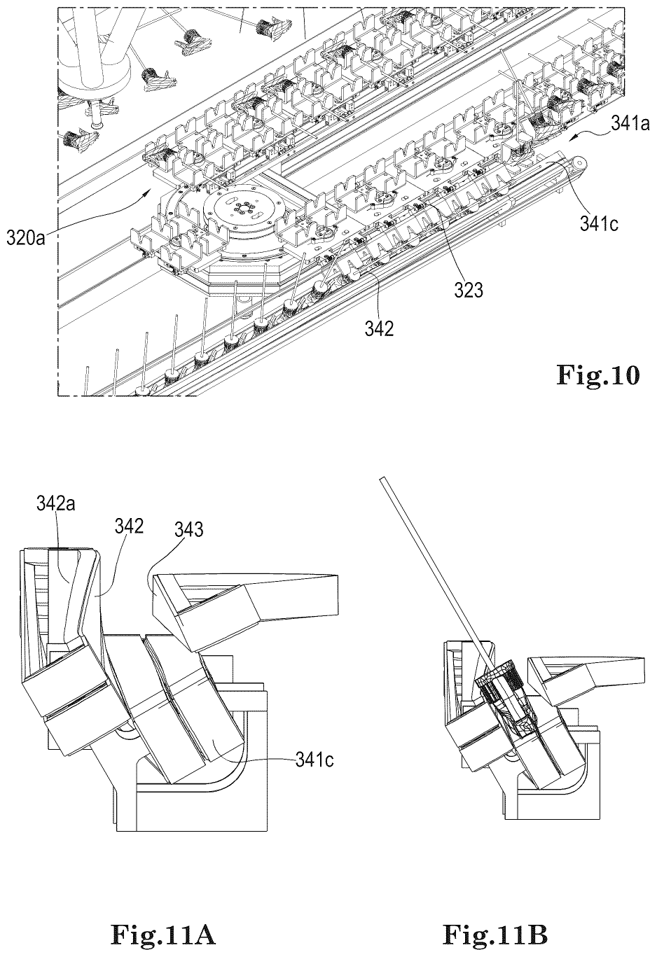

FIG. 10 shows a partial enlarged view of the intermediate transport and extraction systems of the apparatus according to FIG. 9;

FIGS. 11A, 11B show a rear view of the transition assembly of the transport system according to FIG. 10, without and with a trigger;

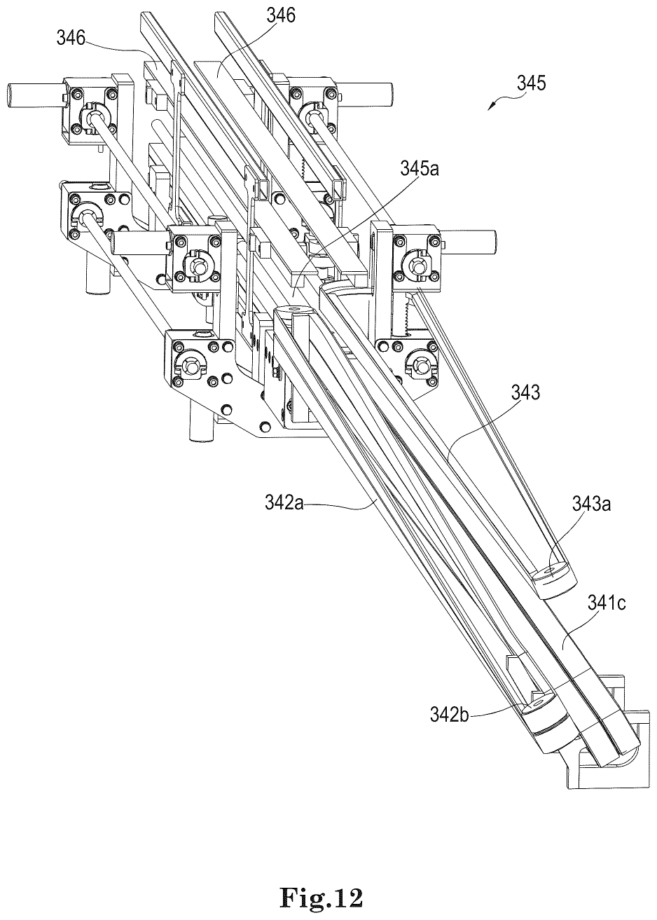

FIG. 12 shows a perspective view of a preferred embodiment of an extraction transport system for transporting closing elements in the form of triggers;

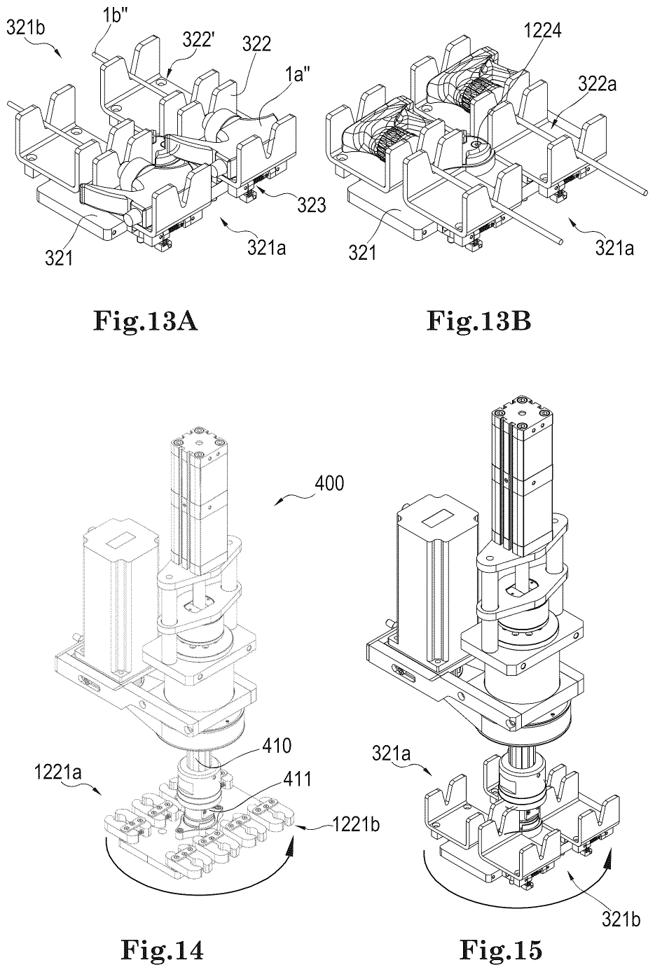

FIGS. 13A,13B show a support plate which carries a plurality of trigger-holder trays, with seats for holding different trigger formats; and

FIGS. 14-15 show perspective views of an auxiliary device for rotation of the support plates according to FIGS. 6A, 13A, 13B.

With reference to FIGS. 1-2 and assuming solely for the sake of easier description and without a limiting meaning, a set of three axes, i.e. longitudinal lengthwise axis X-X, parallel to a direction of feeding of the closing elements 1 from upstream M to downstream V on an input conveyor plane 110; transverse axis Y-Y, parallel to a widthwise direction of the transport plane; and vertical axis Z-Z, perpendicular to the preceding axes, a first embodiment of a sorting apparatus 100 for sorting randomly fed closing elements 1 comprises an input conveyor plane 110 which transports in a longitudinal feeding direction x1 a plurality of closing elements, in the example consisting of caps 1 with a top head 1a, a bottom cavity 1b and a side wall with an elliptical cross-section, which are fed randomly arranged on the conveyor plane 110 rom upstream to downstream.

The plane 110 may for example consist of the movable surface of a conveyor belt which supports and transports the closing elements, for example actuated by suitable motor-driven rollers. It is understood that the longitudinal feeding direction x1 could also not be straight over its entire length, but comprise one or more bends.

One or more pick and place devices 130 are arranged at the conveyor plane 110 and controlled to pick up a closing element 1 from the input conveyor plane and position it in an intermediate transport system 120 with a predefined intermediate position and/or orientation. The first intermediate transport system 120 of the example shown comprises a second conveyor plane 121 on which the picked-up caps 1 are positioned with the intermediate position and orientation, in the example in a vertical position resting on the head 1a with the bottom mouth directed upwards.

A detection system 60 is designed to detect the position and orientation of caps 1 in transit on the input conveyor plane and to make the information available to a processing and control unit 500 (shown only in schematic form) for controlling the pick and place devices 130. The devices 130 are then controlled in order to perform the picking up of a closing element and movements for (re)orientation and positioning thereof so as to position it in the intermediate transport system 120 with the predefined intermediate position and/or orientation. The movements may be different depending on the detected position and arrangement of the closing element 1.

In the preferred embodiment shown, said system 60 comprises at least one telecamera 61,62 arranged upstream of an associated pick and place robot 131,132 in the direction of feeding x1 on the transport plane 110. Each telecamera is designed to detect the position and arrangement of the caps 1 in transit on the transport plane within its viewing field, making the information available for controlling the operation of the respective robot 131,132. Telecameras of this type are known in the sector of sorting machines and are not described in greater detail.

The detection system 60 may preferably comprise also means for measuring the advancing movement of the transport plane, for example comprising an encoder associated with the means for moving the conveyor belt.

The first intermediate transport system 120 is arranged alongside, in the transverse direction Y-Y, a section of the input conveyor belt 110 and is configured to transport the flow of caps 1 arranged thereon by the pick and place devices 130, feeding them downstream to the input of a first extraction system 140.

The first extraction system 140 is configured to receive at its input 141 the elements transported by the intermediate system 120, reorient them if necessary and output an orderly flow of closing elements 1 arranged with a predefined extraction position and/or orientation, which generally is that predefined for the feeding to downstream operating machines (not shown) for subsequent capping operations.

The first extraction system 140 of the example shown comprises a transition assembly 141, designed to receive at its input 141a the caps 1 fed by the belt 121 of the first intermediate transport system 120 and to output them with the predefined extraction position and/or orientation to an extraction conveyor belt 145, which outputs in the downstream direction the orderly flow of closing elements arranged with the predefined extraction position and/or orientation.

The transition assembly 141 of the first extraction system 140 is in the form of a duct descending in a curvilinear manner (also called “twist” hereinafter), the input 141a thereof being fed by the intermediate conveyor belt 121 and the output 141b thereof feeding the flow of caps to the extraction conveyor belt 145.

An output part 122 of the intermediate transport system is advantageously formed with connection means for performing feeding to the input of the extraction system 140, which, in the example of the first intermediate system 120, comprise a descending curve 122 of the intermediate transport plane 120 which feeds the input 141a of the twist 141.

In the example shown, the descending twist 141 is configured internally so as to impart a rotation to each cap 1 between the input 141a and the output 141b, in particular a rotation of 180 degrees about a longitudinal axis, which brings each cap into a vertical position resting on the bottom with the head 1a at the top. This may be realized for example by means of a suitable configuration of the internal surface of the descending duct.

As shown in FIGS. 3A-3C, depending on the form of the cap 1 and the predefined intermediate positions and orientations (obtained by means of the pick and place robots 130) and extraction positions and orientations, the twist may be configured to impart to each cap 1 a rotation of between 0 and 180 degrees, in particular 180 degrees (FIGS. 2,3A), a rotation of 90 degrees (FIG. 3B, for example for asymmetrical caps 1d such that the intermediate position is laid flat on one side) or no rotation (FIG. 3C, for cylindrical caps 1e such that the intermediate position is vertical with the head directed upwards).

It is therefore clear how the first transition system and the first extraction system are able to sort different formats of closing elements in the form of caps 1. Upon variation of the cap format, it is in fact possible to modify the pitch, the orientation and/or the extraction position of the flow of sorted caps 1 depending on the new format, by means of simple replacement of the transition assembly 141 and/or by setting a different intermediate position/orientation, which can be configured for example by varying a control mode of the pick and place robots 130 by means of the unit 500.

The input plane 110, the first intermediate system 120, the robots 130 and the first extraction system 140 form in other words a first sorting line for sorting the closing elements, in particular caps 1, wherein the method for sorting the randomly arranged elements into the orderly flow with the desired extraction position and/or orientation is regulated by the combination of the orientation and positioning settings of the robots 130 for the intermediate position/orientation and by the configuration of the twist 141.

As shown, preferably, the input longitudinal advancement direction x1 is parallel and in the opposite direction to the advancement direction x2 for extraction and/or in the intermediate system 120. The preferred apparatus is therefore particularly compact.

With reference to FIGS. 4 and 5, a second embodiment of the sorting apparatus 200 according to the present invention comprises a second intermediate transport system 220 arranged and configured to receive closing elements 1′ of a different type or format to the caps 1 and to feed them to the input of a second extraction system 240 configured to output an orderly flow of closing elements 1′ of a different type or format, arranged with a predefined extraction position and/or orientation.

In the preferred arrangement, the second intermediate transport system 220 is arranged alongside, in the transverse direction Y-Y, the first intermediate transport system 110. The two intermediate systems 120, 220 may be arranged at different heights in the vertical direction. The second extraction system 240 is arranged alongside the second intermediate transport system 220 in the transverse direction Y-Y, on the opposite side to the first intermediate system 120.

The pick and place devices 130 advantageously are arranged and are controllable so as to pick up one of said closing elements 1′ of a different type or format arranged randomly on the input conveyor plane 110 and to position it in the second intermediate transport system 220, with a predefined intermediate position and/or orientation. The robots 131,132 are in particular controlled by the control unit 500 depending on the position and orientation information emitted by the detection system so as to pick up a closing element from the conveyor plane 110 and perform movements for (re)orientation and positioning thereof so as to position it in the intermediate transport system 220 with the predefined intermediate position.

The second intermediate transport system 220 is configured to transport closing elements 1′ of a different type, for example sprayers 1′. For this purpose, it comprises a plurality of holding elements 222 for holding a respective closing element 1′, in this case configured to hold the neck 1n situated underneath the head 1a′ of a sprayer 1′, arranged in a vertical upright position with the head 1a′ at the top. In the preferred example shown, the front side F is directed towards the outside of the intermediate transport system 220. The holding elements 222 are movable between a positioning zone 220a for positioning by the devices 130 and an output part situated in correspondence of an input 241a of the output extraction system 240.

In greater detail, the holding elements 222 move along a circuit 225 between the positioning zone 220a and the input 241 of the extraction system 240. The circuit 225 is preferably an oval (or closed loop) circuit with straight sections, i.e. an outward section 225a, which includes the positioning zone 220a, and return section 225b, which passes by the input 241a of the extraction system 240. The straight sections 255a,255b are connected by curved joining sections 225c.

The movement trajectory along the circuit lies preferably in a plane parallel to the input plane 110 and/or to one of the output extraction planes 145,245. The direction along the output section 225a is in the example parallel to the longitudinal extraction direction x2, and the direction x3 along the return section 225b is parallel to the longitudinal direction x1 for feeding of the elements on the input plane 110. Along the straight sections, the holding elements are in particular arranged at predetermined regular intervals.

As shown, the closing elements therefore rotate through 180 degrees about a vertical axis between the position at the input 220a into the intermediate system 220 and the input 241a into the extraction system.

Each holding element 222 is in the form of a gripper configured to hold the neck 1n of the sprayer. Each holding element 22 may in particular comprise a pair of oppositely arranged jaws 222a. The jaws 222a are preferably coupled together with interposed resilient means 222c (FIG. 6A) designed to bias them towards a relative closing position for holding the neck of the sprayer. For positioning by the pick and place devices 130, it may be sufficient to insert the closing element 1′ between the jaws of the gripper 222, with a slight pressure by the closing element 1′ moved by the robot 131 so as to cause the temporary spreading of the jaws 222a, against the action of the resilient means 222c.

As shown in FIGS. 4 and 5, the intermediate transport system 220 comprises a plurality of support elements 221, in particular support plates 221, movable along said circuit between the positioning zone 220a and the input 241 of the extraction system 240.

Each gripper 222 is mounted cantilevered on one of the movable supports 221. Preferably, each support 221 comprises a plurality of holding elements 222 arranged at predefined regular intervals along an operating side thereof. The holding elements 222 may be configured to hold closing elements 1a′ with different formats. The grippers 222 are in fact particularly suitable for holding the neck 1n of the sprayers, which is generally cylindrical, also upon variation of the outer form of the overlying head 1a′. The two jaws may define between them a vertical axis seat which is suitably shaped to hold the neck 1n of the closing element.

Moreover, as will be described below with reference to FIGS. 6A-C, each support 221 preferably carries a plurality of holding elements 222 designed to hold closing elements with different formats, for example by means of different prestressing of the resilient means 222a and/or by means of jaws 222a of the grippers 222 realized with different forms and dimensions suitable for gripping different sprayer formats.

The second extraction system 240 is designed to receive at its input 241 the closing elements 1′ transported by the intermediate system 220 and to output an orderly flow of closing elements 1′ arranged with a predefined extraction position and/or orientation, which in the preferred example shown is an upright position with the head 1a′ directed upwards and rear side directed in the advancement direction x2 for output from the extraction system 240. Said extraction position and orientation is particularly advantageous for extracting closing elements of the sprayer type 1′.

The second preferred extraction system 240 shown comprises a transition assembly 241 which intercepts at its input 241a the sprayers 1a′ transported by the holding means 22 and outputs them to an output conveyor 245 which is generally in the form of a longitudinal/transverse transport plane 245 formed with two extraction side shoulders arranged opposite each other in the transverse direction, the upper transport half-planes 245a,245b thereof supporting a bottom surface of the head 1a′ of the sprayer, and a central cavity which allows the bottom vertical stem 1b′ to pass through.

The transition assembly 241 comprises a star wheel 242 rotating about a vertical axis and provided with a plurality of vertical-axis seats 242a for housing a respective closing element 1′, the seats being arranged at a predefined angular distance from each other along a circumference. Each seat 242a is designed to house a part (generally with a larger diameter) of the head 1a′ of the sprayer 1′ different from that held by the grippers 222. The angular distance between the seats 242a and the direction and speed of rotation of the star wheel 242 are suitably configured to intercept the closing elements 1a′ carried by the grippers 222 when they pass by the input zone 241a, capturing them inside a respective seat of the rotating star wheel.

A curved guide 243 is arranged in a position radially on the outside of the star wheel 242 between the input position and the output towards the extraction plane 245, in order to contain and guide the sprayers 1′ arranged inside the seats during rotation. The guide 243 has a projecting free end 243a at the input 241a into the transition assembly, designed to channel the sprayers 1′ in transit and favour their separation from the holding means 222 as a result of the action of the rotating star wheel 242. The opposite end of the guide 243 is instead arranged in the proximity of the input to the extraction plane 245.

Should the extraction direction x2 for extracting the closing elements 1′ in the extraction system and the longitudinal direction of advancing movement of the holding means 222 to the input 241a in the extraction system (therefore along the return branch 225b) be concordant, the transition assembly 240 could consist of a simple grooved guide, for example in the form of an S, suitable for intercepting the sprayers 1′ in transit and channelling them towards the extraction plane 245.

Owing to the intermediate transport system 220, it is in fact generally not necessary to change the position of the sprayers 1′ by means of rotation about axes different from the main vertical axis, between the intermediate position and the final extraction position.

It is therefore clear how the second transition system 220 and the second extraction system 240 allow the sorting of closing elements of the sprayer 1′ type, different from the closing elements of the cap type 1 able to be sorted by the first sorting line 110, 120, 130,140 for caps 1.

The input plane 110, the second intermediate system 220, the robots 130 and the second extraction system 240 form in particular a second sorting line for sorting closing elements 1′ of a type different from that of the first sorting line, wherein the method for sorting the elements 1′ randomly arranged on the conveyor plane 110 into the orderly flow with a desired extraction position and/or orientation is regulated by the combination of the orientation and position settings of the robots 130 for the intermediate position/orientation and by the configuration of the holding means and of the second extraction system 240.

FIGS. 6A-6C show a particularly preferred example of the support plate 1221, which comprises a plurality of holding elements 222, 222′ arranged at regular intervals on a first longitudinal side 1221a of the support plate 1221. As shown in FIG. 6A, advantageously, only some 222′ of said holding elements may be designated as active for sorting, for example depending on a desired pitch for entry 241a into the extraction system 240. In use, the control unit 500 will control the pick and place robots 130 so that they position the closing elements 1′ only in said holding elements 222′ which are designated as active.

Furthermore, these holding elements 222,222′ are preferably arranged in the manner of at least two series of holding elements, with the grippers 222 of the first series arranged alternating with the grippers 222′ of the second series of holding elements. As shown in FIG. 6B, each series of holding elements 222,222′ may be adapted or designated to hold closing elements 1′ with a different format.

Preferably, the support has a second longitudinal side 1221b, opposite to the first side 1221a.

One or more series of holding elements are arranged on the first side 1221a and one or more additional series of holding elements for holding different closing elements are arranged at regular intervals on the second side 1221b. Therefore, during use, the plate 1221 will have an operative side which receives and holds the closing elements 1′, directed towards the outside of the intermediate transport system 220, and an opposite standby side, directed towards the inside. Although illustrated as being identical, it is understood that the grippers 222,222′ of one series will be preferably different from those of another series.

The plate furthermore comprises coupling means 1224 for coupling to an auxiliary device for rotation of the plate 1221 about a vertical axis, which will be described in greater detail below with reference to FIGS. 12-13.

As can be seen in FIG. 6C, the supports 121 with multiple holding elements 222,222′ are therefore particularly versatile for managing different formats of closing elements 1′ and/or different parameters of the sorting and extraction process, without the need for complicated replacement of the holding elements 222.

With reference to FIGS. 7 and 8, the plates 1221 are mounted on respective carriages which move on a guide which defines the oval circuit of movement of the plates.

Each plate 1221 is provided with means (not shown) for coupling to the respective carriage, which are configured to switch between a first operative position, in which the plate is rigidly secured to the carriage, and a second position, in which the plate 1221 is coupled to the carriage with the possibility of rotating about a vertical axis perpendicular to the plane of the plate. Preferably, the mechanism for coupling together plate and carriage is such that, by exerting a downwards pressure on the plate, it switches from said first operative position into said second operative position, in which it may rotate with respect to the carriage without however being disengaged therefrom.

The plates 1221 are moved along the circuit by actuating means; for example, in the embodiment shown, the carriages are provided with roller wheels which engage with the oval guide and are attached to a belt moved by a motor-driven pulley. In this embodiment the carriages are therefore not independent of each other.

In a variation of embodiment, the carriages may instead by moved individually along the oval guide by means of independent actuating means which are controlled by the central control unit 500 which is also preferably designed to vary the speed of advancing movement of the said carriages along the different sections of the guide. In an example of embodiment, each plate is coupled to a carriage which includes permanent magnets, and the system for actuating the carriages comprises a linear motor comprising electric windings integral with the fixed guide and preferably extending along the whole length of the guide. With this configuration, the magnets and therefore the carriages are moved and controlled in terms of position and speed by the magnetic field generated by the aforementioned fixed windings.

As can be seen in FIG. 8, in the example shown only the second and the fourth holding element 222 of each plate 1221 are used, forming a second series of holding grippers arranged at regular intervals in the positioning zone 1220a and along the straight section of movement towards the input 241a of the extraction system 240.

As shown in FIG. 8, it is envisaged that, in preferred embodiments of the extraction system 140,240 for output transportation, the extraction conveyor plane or belt 145,245 comprises vertical containing side shoulders 246 which extend parallel to the advancement direction x2 of the closing elements 1′ being extracted, at a height above the extraction plane 245. The containing side shoulders 246 are designed to reduce the possibility of the closing elements 1,1′ falling/being overturned at the moment of their entry into the extraction plane and/or during advancement towards the output. The two opposite shoulders may be movable and/or motorized so that they can be displaced in the transverse direction Y-Y and/or vertical direction in order to adjust the interaxial distance to the actual corresponding transverse dimensions of the different closing elements.

With reference to FIGS. 9 and 10, a third embodiment of the sorting apparatus 300 of the present invention comprises a different second intermediate transport system 320, arranged and configured to receive closing elements 1″ of type or format different from that of the caps 1 and the sprayers 1′, in particular of the type with a head 1a″ provided with a trigger on a front side F thereof.

The second extraction system 340 is in turn configured to output an orderly flow of closing elements 1″, arranged with a predefined extraction position and/or orientation, which in the case of triggers 1″ is preferably an upright vertical position, with the head 1a″ oriented downwards and the rear side B directed forwards in the extraction advancement direction x2.

The second intermediate transport system 320 is configured to transport the closing elements 1″ of the trigger type from a positioning zone 320a, in which they are positioned by the robots 130, to an exit part for output towards an input 341a of the extraction system. For this purpose, it comprises (FIGS. 9,10,11A,11B) a plurality of holder elements 322 for holding a respective closing element 1″, in this case configured to hold the trigger 1″ in a position laid flat with the head 1a″ directed towards the outside of the intermediate transport system 320. The triggers 1″ are in particular laid flat with a side surface thereof on a substantially longitudinal/transverse plane, with the rear side B directed in a same direction, in particular forwards, relative to a direction of advancement in the intermediate transport system 320.

The holding elements 322 are movable between the positioning zone 320A and the exit zone for output towards the input 341a of the output extraction system 340.

In a manner similar to that described above, the holding elements 322 move preferably along an oval circuit 325 between the positioning zone 320a and the input 341a of the extraction system 340. In this example of embodiment, the direction of advancement along the outward section is parallel to and in the same sense as the longitudinal direction x1 of feeding of the elements on the input plane 110, and the direction along the return section is parallel to and in the same sense as the longitudinal direction x2 of advancement in the extraction system. Along the straight sections of the circuit, the holding elements 322 are in particular arranged at predetermined regular intervals. As shown in FIGS. 10 and 13A, each holding element is in the form of a tray 322 which defines a compartment 322a for housing the closing element 1″ which is open upwards. In particular, the tray has a substantially U-shaped form with a bottom resting plane for the head 1a″ of the trigger 1″ and two opposite vertical containing walls projecting upwards from the bottom plane and situated opposite each other in a transverse direction, parallel during use to the direction of the main axis (of the stem 1b″) of the closing element 1″. At least the internal wall is fork-shaped with a vertical recess designed to allow insertion and holding of the stem 1b″ of the trigger 1″.

The support plane of each tray is coupled to a support plate 321 by means of hinging means 323 for rotation about a longitudinal axis, configured to allow rotation of the tray 322 from the holding position into an overturned position, where the triggers 1″ fall by means of gravity towards the input 341a of the extraction system 340, in a position rotated about the longitudinal axis through an angle greater than or equal to 90 degrees. These hinging means 323 comprise for example a hinge with longitudinal pin.

The guide of the movement circuit 324 for the trays 322 has advantageously cam means designed to act on the tray so as to cause the overturning rotation thereof at the input 341a of the extraction system 340. For example, the cam means may include a linear cam with an upper profile which acts on a bottom surface of the tray 322. Downstream of the input 341a of the extraction system there may be present means for righting the tray, for example comprising second cam means with a profile which is the reverse of the profile of the overturning cam. In an alternative embodiment, the hinging hinge 323 may comprise resilient means, configured to cause an elastic return of the tray into the holding position, downstream of the input 341a of the extraction system.

The trays 322 are therefore arranged at predetermined regular intervals in the positioning zone 320a, where they receive a respective trigger 1″ positioned with said intermediate position and orientation by a robot 131. The trays 322 then move along the oval circuit as far as the input zone 341a of the extraction system, where they are rotationally actuated into the overturned position in which they release the triggers 1″ to the extraction system 340. In addition to the change in orientation by means of rotation through 180 degrees about the vertical axis, determined by the movement along the circuit, the closing elements 1″ are thus arranged in a second intermediate position for their entry into the extraction system 340, said position being rotated by at least 90 degrees with respect to the flat position, but not yet completely upright in the vertical direction.

The extraction system 340 for extracting and advancing the closing elements 1″ downstream is configured to receive at its input 341a the elements 1″ arranged in said second intermediate position and orientation and to output them in the extraction direction x2 so that they arranged in an orderly flow with a predefined extraction position and orientation, which is preferably a vertically upright position with the head 1a″ downwards, the stems 1b″ upwards and the rear side B directed forwards in the extraction direction x2. The extraction system 340 comprises a transition assembly 341 which includes said input 341a where the triggers 1″ fall from the holding trays 322 into said second intermediate position and orientation.

The transition assembly 341 is configured to transport the triggers 1″, varying the position and/or orientation thereof, so as to feed them to the input of an extraction conveyor 345 with the predefined extraction position and/or orientation. The extraction conveyor 345 then outputs the orderly flow of closing elements, arranged with the predefined extraction position and/or orientation and advancing in the longitudinal extraction direction x2. In particular, the transition assembly 341 is designed to vary the position of the triggers 1″ from the second intermediate position into the predefined vertically upright extraction position by means of rotation about a longitudinal axis.

With reference to FIGS. 10-12, the preferred example of a transition assembly 341 shown comprises an inclined bottom transport plane 341c on which the triggers 1″ fall in said second intermediate position, with the head 1a″ resting on the inclined bottom plane 341c; the inclined plane 341c is arranged adjacent in the transverse direction Y-Y and underneath the holding means 322 of the intermediate transport system 320, at the input 341a of the extraction system 340. The inclination of the bottom plane 341c varies gradually between the input 341a of the extraction system and the input of the extraction plane 345, until it becomes horizontal, namely parallel to the transverse direction Y-Y and the longitudinal direction x2 of extraction. The bottom plane 341c is preferably formed by a conveyor belt wound around rotating drive rollers, with axes of rotation respectively: inclined so as to correspond to the initial inclination of the bottom plane 341c and parallel to the transverse direction at the output of the transition assembly. The conveyor belt 341c may for example be formed by one or more belts wound around said rollers.

A first inclined side belt 342 is arranged adjacent to the bottom transport plane 341c in the transverse direction Y-Y and is designed to support laterally the closing element 1″; the side belt 342 is in particular arranged on the outside of the first plane 341c, on the opposite side to the intermediate transport system.

The inclined side belt 342 has an inclination which varies gradually between the input 341a and the output of the transition assembly. At the input 341a, the belt is inclined from the outside towards the inside in the transverse direction and from the top downwards in the vertical direction Z-Z so as to form, for example, an angle substantially at 90 degrees with the bottom transport plane 341c. In its end part which leads to the input of the extraction conveyor 345, the first side belt is oriented parallel to the vertical direction Z-Z. The side belt 342 is therefore designed to cooperate with the inclined bottom plane 341c so as to impart to the triggers 1″ a gradual further rotation about the longitudinal axis, so as to bring them into the predefined vertically upright extraction position. Said side belt 342 may be preferably in the form of one or more belts 342a wound around drive rollers 342b, acting on the cylindrical part of the head 1a″ of the trigger so as to impart to the trigger said further rotation.

Preferably, the transition assembly 341 furthermore comprises a second inclined side belt 343 arranged laterally with respect to the first inclined plane 341c on the opposite side to the first side belt 342. The second belt extends from a point downstream of the input 341c of the transition assembly, situated after the start of the bottom plane 341c and of the first side belt 342, as far as the output of said assembly which feeds the extraction conveyor 345. The second side belt 343 has an inclination which varies gradually as far as its end part which leads to the input of the extraction system, where the belt is oriented parallel to the vertical direction Z-Z. The inclination of the third belt may be substantially parallel to the inclination of the first side belt 342. Said second side belt 343 may be preferably in the form of a belt wound around a drive roller 343a.

With reference to FIG. 12, the output conveyor 345 may be in the form of a conveyor belt 345a which defines a longitudinal/transverse extraction plane, with vertical side shoulders 346,347 which laterally contain the triggers 1″ for transportation in the longitudinal extraction direction x2 in the vertical upright position with the head at the bottom.

In greater detail, the extraction conveyor 345 may include a pair of containing side shoulders 346 arranged opposite each other in the transverse direction and arranged on opposite sides of a line of advancement of the closing elements along the conveyor plane 345. The shoulders are mounted on vertical uprights movable in the vertical direction and/or transverse direction in order to adjust the height and the distance of the pair of containing shoulders 346. In the case of trigger-type closing elements 1″, preferably the shoulders are arranged so as to contain the closing element both laterally and from above, with respective containing planes arranged laterally and above the closing element.

With reference to FIGS. 13A, 13B and in a manner similar to that shown with reference to the support plate 1221 shown in FIGS. 6A-6C, the support 321 for carrying the trays 322 has preferably a first longitudinal side 321a along which a series of holding trays 322 are hinged at a regular distance and a second longitudinal side 321b, opposite to the first side 1221a in the transverse direction, along which a further series of holding trays 322′ are hinged at a regular distance. Preferably, each support 321 carries two or more trays 322 on each side.

Therefore, during use, the support plate 321 will have an operative side 321a which receives and holds the closing elements 1″ in the trays 322 hinged therewith and which is directed towards the outside of the intermediate transport system 320 in the transverse direction, and an opposite standby side, directed towards the inside. Although shown as being identical, it is understood that the seats defined by the trays 322,322′ of the two sides 321a,321b are preferably different, so as to hold triggers 1″ with a different format, as schematically shown in FIG. 11B. In a further preferred embodiment, the trays 322 are configured with adjustable size seats; for example, one or both the vertical walls of each seat may be movable towards or away from each other in order to adjust the size of the respective seat.

The support plate 321 also furthermore comprises means 1224 for coupling to an auxiliary device for rotation of the plate 321 about a vertical axis, which will be described in greater detail below with reference to FIGS. 14-15.

With reference to FIGS. 14 and 6A-6C, each support 1221 carrying holding means 220 is preferably provided with coupling means 1224 designed to be engaged by rotation means of a device 400 for gripping and rotating the support 1221. In the example shown, these coupling means 1224 are in the form of a disc mounted on the top surface of the support plate 1221, in a substantially central position, and provided with a pair of shoulders projecting upwards in the vertical direction Z-Z, preferably with a curved profile.

The gripping and rotation device 400 comprises in particular an arm 410, the bottom end of which is movable in both senses of the vertical direction Z-Z between a raised position and a lowered position for engagement with the plate 1221, upon control of actuating means, for example of the electric actuator type. The bottom end of the arm 410 is provided with a rotating spindle 411, configured with engagement means for coupling with the coupling means 1224 of the plate 1221, against which it stably engages.

During use, the device 400 may be arranged in a predefined position along the circuit 225 for movement of the supports 1221 or be displaceable from a position outside the circuit into a position situated above the circuit, by means of a corresponding actuating means.

Once the plate 1221 is positioned in a coaxial position underneath the rotating spindle 411, the arm 410 is actuated into the lowered position, resulting in coupling of the engagement means with the coupling means 1224 of the plate 1221.

The engagement means may be designed to expand radially in order to cause the stable gripping of the projecting shoulders of the coupling means 1224 of the plate 1221, actuated by a respective actuating device.

Once the plate 1221 is engaged, the spindle 411 is lowered further, switching the mechanism for coupling the support plate 1221 to the carriage, by means of which it is mounted on the guide 225, into the second operative position in which the plate is coupled to the carriage with the possibility of rotating about a vertical axis. The spindle 411 is then rotationally actuated about the vertical axis (FIG. 14) so as to rotate the plate 1221, for example through 180 degrees, so as to bring the side 1221b, which was previously in the standby position, into the operative position. In this way, the holding jaws 222,222′ on the standby side are made operative for holding closing elements with a different format.

With reference to FIGS. 13A, 13B and 15, the support plates 321 which carry the trays 322 for holding the triggers 1″ may be rotated in a similar manner, so as to arrange the standby side 321b, which has compartments for holding different-format triggers 1″, into the operative position.

Therefore, by means of the assembly consisting of the support plates 1221, 321 with coupling means and the device for rotation of the plates 400, it is possible to carry out in a quick and easy manner a process for changing the format of the apparatus in order to sort closing elements with a different format.

According to preferred embodiments it is envisaged that the pick and place robots 131,132 have a number of axes of rotation and/or degrees of freedom less than or equal to five, so as to be able to simplify the orientation and positioning movements of the closing elements and therefore ensure a high speed and efficiency of the picking-up and placing in the intermediate transport system. Owing to the versatility of the intermediate transport system and extraction systems during reorientation and positioning of the closing elements it is in fact not necessary for the robots 130 to perform, prior to release, complicated movements for orientation and positioning of the articles requiring more than five degrees of freedom and/or axes of rotation, said operations being time-consuming and penalizing the performance of the sorting machine, as well as resulting in the need to use complex and costly robots.

Although described in connection with a number of embodiments and a number of preferred examples of implementation of the invention, it is understood that the scope of protection of the present patent is determined solely by the claims below.

1-22. (canceled)

23. A sorting method for sorting randomly fed closing elements, comprising:
transporting a plurality of closing elements for closing containers, arranged randomly on an input conveyor plane;
detecting the position and the arrangement of the closing elements in transit on the input conveyor plane, by means of a detection system and making the information available to a control unit for controlling one or more pick and place devices;
picking up one or more closing elements arranged randomly on the input conveyor plane and positioning them in a first intermediate transport system with a predefined intermediate position and/or orientation, by means of said one or more pick and place devices which perform movements for orientation and positioning of the picked-up closing elements, controlled by the control unit based on the position and arrangement information detected;
transporting the one or more closing elements positioned in the intermediate transport system to the input of an extraction system, with feeding of the closing elements into the extraction system;
outputting from the extraction system an orderly flow of closing elements which advance with a predefined extraction position and/or orientation;
wherein the extraction system comprises: a transition assembly, which includes the input of the extraction system which receives the plurality of closing elements and feeds to an output of the transition assembly the closing elements received at its input, arranged with the predefined extraction position and orientation; and an extraction conveyor which receives at its input the closing elements output from the transition assembly and transports to its output the orderly flow of closing elements which advance in an extraction direction with the predefined extraction position and orientation,
whereby the input plane, the intermediate transport system, the pick and place devices and the extraction system form a sorting line for sorting closing elements,
wherein the method for sorting the randomly arranged elements in order to obtain the orderly flow with the predefined extraction position and orientation is regulated by the combination of the orientation and positioning settings of the pick and place devices for the intermediate position and orientation positioning and by the configuration of the transition assembly;
wherein
the extraction conveyor defines a longitudinal-transverse transport plane on which the closing elements advance arranged with said predefined extraction position and/or orientation, and in that the longitudinal-transverse transport plane is formed by two side extraction shoulders which are arranged opposite each other in the transverse direction and the two upper transport half-planes of which support a bottom surface of the head of the closing element, between the two side shoulders there being defined a central cavity which allows transit of a bottom vertical stem of the closing element.

24. The method according to claim 23, wherein the one or more pick and place devices each perform orientation and positioning movements which require a number of axes of rotation and/or degrees of freedom less than or equal to five.

25. The method according claim 23, wherein the transition assembly receives at its input the closing elements with a first position and/or orientation and transports the closing elements, varying the position and/or orientation thereof, so as to feed them to the input of the extraction conveyor with the predefined extraction position and/or orientation.

26. The method according to claim 25, wherein the transition assembly varies the position of the elements by means of a rotation about a longitudinal axis, perpendicular to a main vertical axis of the closing element, and/or wherein the transition assembly varies the orientation of the closing elements by means of a rotation about a main vertical axis of the closing element.

27. The method according to claim 23, wherein the closing elements include one or more of the following types of closing element:
closing elements of the type in the form of a cap 1, with a top head 1a and a bottom cavity 1b arranged opposite each other along a main vertical axis and connected by a side surface;
closing elements of the sprayer type which have a top head with dispenser, a neck situated underneath the head and a bottom stem extending along a main vertical axis;
closing elements of the type with a top head having a trigger on a front side (F) thereof and with a bottom stem extending along a main vertical axis.

28. The method according to claim 27, wherein at least one of the predefined intermediate position and orientation and the predefined extraction position and orientation is a vertical upright position with the head directed upwards.

29. The method according to claim 23, wherein the transition assembly includes a duct descending in a curvilinear manner between the input of the extraction assembly and the output of the transition assembly, configured internally so as to impart to each closing element a rotation about a longitudinal axis of between 0 and 180 degrees, in particular a rotation of 90 degrees or 180 degrees.

30. The method according to claim 23, wherein the transition assembly comprises:
a star wheel rotating about a vertical axis and provided with a plurality of vertical-axis seats for housing a respective closing element, the seats being arranged at a predefined angular distance from each other along a circumference; or
an S-shaped grooved guide designed to intercept the closing elements received at the input and to channel them towards the extraction conveyor.

31. The method according to claim 23, wherein the predefined intermediate position and/or orientation for transporting the closing elements with trigger head is a position laid flat on a side surface thereof, and/or wherein the predefined extraction position and/or orientation for the orderly flow of closing elements with trigger head output from the extraction system is a vertical upright position, with the head directed downwards.

32. The method according to claim 31, wherein the transition assembly comprises an inclined bottom plane for transporting the closing elements between the input of the extraction system and the output of the transition assembly; and an inclined side belt arranged adjacent to the inclined bottom plane; wherein the closing elements input into the extraction system are arranged in a first position with the head resting on the inclined bottom plane, and wherein said bottom plane and said side belt have an inclination which varies gradually between the input and the output of the transition assembly so as to impart to the closing elements a gradual rotation about a longitudinal axis, perpendicular to the main axis of the closing element, so as to bring them into the predefined vertical upright extraction position.

33. The method according to claim 32, wherein the bottom plane is formed by a conveyor belt wound around a rotating input roller, with axis of rotation inclined so as to correspond to the initial inclination of the bottom plane and a rotating roller arranged at the output of the transition assembly, with axis of rotation parallel to the transverse direction.

34. The method according claim 32, wherein the transition assembly further comprises a second inclined side belt, arranged alongside the first inclined plane on the opposite side to the first side belt, and having an inclination which varies gradually as far as the output of the transition assembly; the second belt preferably extending from a point downstream of the input of the transition assembly, arranged after the start of the bottom plane and the first side belt, as far as the output of the transition assembly.

35. The method according to claim 34 wherein:
the bottom belt is formed by one more belts wound around said rotating rollers; and/or
said first side belt is formed by one or more belts wound around rotating rollers, with different axes of rotation; and/or
said second side belt is formed by one or more belts wound around one or more rotating rollers.

36. The method according to claim 23, wherein the extraction conveyor includes a pair of containing side shoulders arranged opposite each other in the transverse direction and arranged on opposite sides of an advancement line for advancing the closing elements along the conveyor plane.

37. The method according to claim 36, wherein:
the shoulders are movable in the vertical direction so as to adjust a heigh twise position of the shoulders with respect to the transport plane and/or in the transverse direction so as to adjust a relative distance between the shoulders; and/or
the shoulders have respective containing planes arranged laterally and/or above the transport plane, so as to contain the closing element laterally and/or from above during advancement on the extraction conveyor plane.

38. The method according to claim 23, wherein the intermediate transport system comprises:
a transport plane; or
a plurality of holding elements for holding a closing element, movable between a positioning zone, in which they receive a closing element positioned by one of the pick and place devices, and an exit part for output towards the input of the extraction system, wherein the holding elements move along an oval circuit between the positioning zone and an exit for output towards the input of the extraction system.

39. The method according to claim 38, wherein the intermediate transport system rotates the closing elements through 180 degrees about a vertical axis between the positioning zone at the input into the intermediate system and the input into the extraction system.

40. The method according claim 23, wherein the closing elements are fed to the input of the extraction system with a predefined position and/or orientation different from the intermediate position and/or orientation with which they are positioned in the intermediate transport system and/or different from the predefined extraction position and/or orientation.

41. The method according to claim 40, wherein said predefined position and/or orientation for input into the extraction system is at least one of the following:
a position and orientation rotated through 180 degrees about a main vertical axis of the closing elements, with respect to the intermediate position and orientation;
a position and orientation of each closing element rotated about a longitudinal axis with respect to the intermediate position and orientation and/or the extraction position and orientation, in particular with an angle of rotation of between 90 and 180 degrees.

42. The method according to claim 23, comprising one or more of the following operations:
varying by means of the control unit a control setting of the pick and place devices for positioning the closing elements in the intermediate transport system;
using a different intermediate transport system and a different extraction system, for sorting closing elements of a different type and/or format;
replacing the transition assembly of the extraction system with a different transition assembly for sorting closing elements of a different type and/or format;
using at least two different series of holding elements in the intermediate transport system, in order to vary an input pitch between the closing elements for entry in the extraction system and/or to hold closing elements of a different type and/or format.
